(19) United States
(12) Patent Application Publication
(10) Pub. No.: US 2002/0116543 A1
(43) Pub. Date: Aug. 22, 2002

(54) Dynamic and extractable device information object

(76) Inventor: Rodger Wilson, Superior, CO (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/790,860

(22) Filed: Feb. 21, 2001

(51) Int. Cl. G06F 13/10; G06F 15/163; G06F 9/54; G06F 9/00

(52) U.S. Cl. 709/321

(57) ABSTRACT

In one aspect of the invention, a method to query device information from a device using a generic fetch instruction to request a reusable application component from the device, where the reusable application component has one or more variables each corresponding to device information, and then extracting one or more of the variables from the reusable application component.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

This invention relates to the field of device communications.

### BACKGROUND OF THE INVENTION

The success of the Java programming language developed by Sun Microsystems, Inc.® can be attributable, at least in part, to its platform-independent characteristics. Since Java programs are compiled into byte code, compiled Java code is not refined to the point of relying on platform-specific instructions, and can, therefore, run in a virtual environment existing in software. This virtual environment is known as a Java Virtual Machine environment. Java concepts, such as JavaBeans® and Java Applets® also have these characteristics. A JavaBean®, for example, is a reusable application component—an independent segment—that can be combined with other JavaBean® components to create a Java Applet or application. Java® and its formative trademarks are trademarks or registered trademarks of Sun Microsystems, Inc. of Palo Alto, Calif.

For a device, for example, to take advantage of the platform independence capabilities of Java, i.e., to be Java-enabled, the device typically installs a Java Virtual Machine environment. This entails installing Java interpreters and runtime environments on the device, or installing a Java chip on the device, in order for the device to recognize Java code. The result is that the device is compatible with other Java-enabled devices and computers, one advantage being that no device or computer is unique to a particular platform.

For example, as illustrated in FIG. 1, a device driver on 102 on a Java-enabled computer 100 comprises fetch instructions 104 that are specific to a device being queried, and a Java-enabled device 106 comprises a Java Virtual Machine 108 that allows device information 110 to be encoded in a device-independent manner. As illustrated in the flowchart of FIG. 2 which starts at block 200, when a Java-enabled computer 100 requests device information from a Java-enabled device 106 having a Java Virtual Machine 108, a device driver 102 on the computer 100 sends a specific fetch instruction 104 to the device 106 at block 202, and the device 106 sends back the encoded device information 110. The encoded device information 110 is received at block 204, and the method ends at block 206.

In presently known systems, obtaining device information is a unidirectional process, where only the Java-enabled device is only able to gather information about itself and send it to the requesting computer.

### SUMMARY OF THE INVENTION

In one aspect of the invention, a method to query device information from a device is disclosed. A generic fetch instruction is used to request a reusable application component from the device, where the reusable application component has one or more variables each corresponding to device information. Then, one or more of the variables may be extracted from the reusable application component.

Other features and advantages of the invention will be apparent from the accompanying drawings and from the detailed description.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating a prior art relationship between a computer communicating with a device.

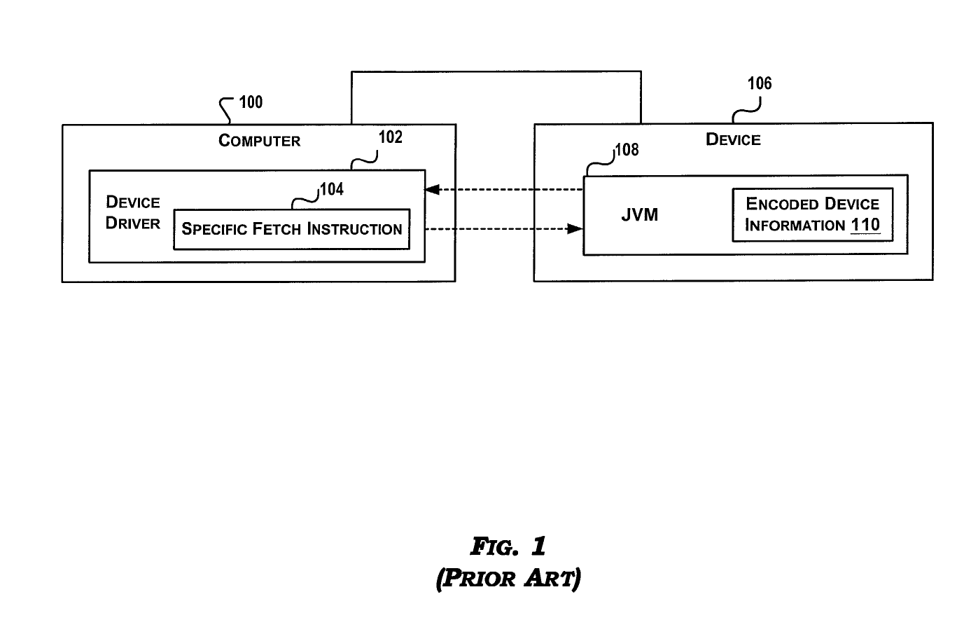

FIG. 2 is a flowchart illustrating a prior art method of communication between a computer and a device.

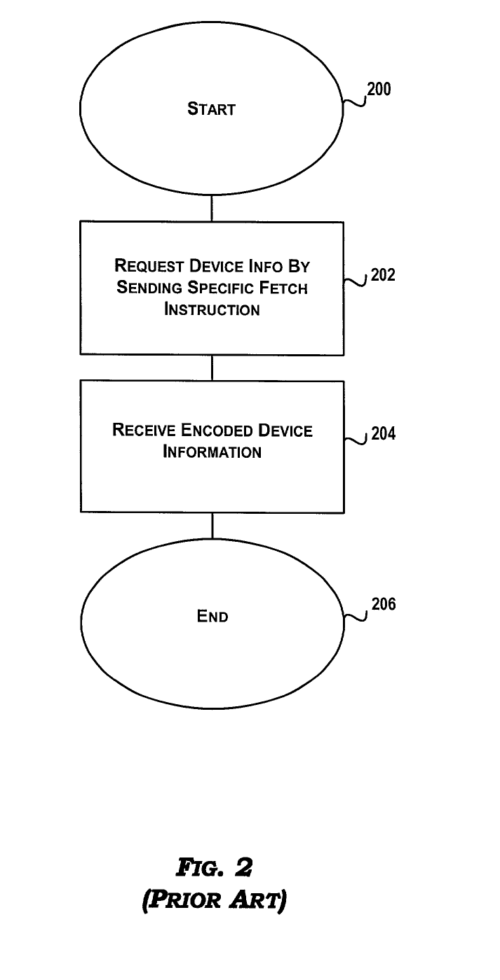

FIG. 3 is a block diagram illustrating a relationship between a computer communicating with a device in accordance with embodiments of the invention.

FIG. 4 is a flowchart illustrating a method of communication between a computer and a device in accordance with one embodiment of the invention.

FIG. 5 is a conceptual diagram of a reusable application component according to one embodiment of this invention.

### DETAILED DESCRIPTION OF THE INVENTION

In one aspect of the invention, a method is disclosed for using a dynamic, extractable device information object to obtain device information from a device. A programmable device memory contains a reusable application component that comprises variables to hold information about the device. The reusable application component is dynamic and extractable: it can be updated with current device information, and can be extracted by other computers and other devices. When a computer, for example, queries information from a device that has a reusable application component, the computer's device driver sends a generic fetch instruction to the device. In response to the request from the computer's device driver, the device sends the reusable application component to the computer's device driver. Device information can then be extracted from the reusable application component.

The present invention includes various operations, which will be described below. The operations of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media / machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

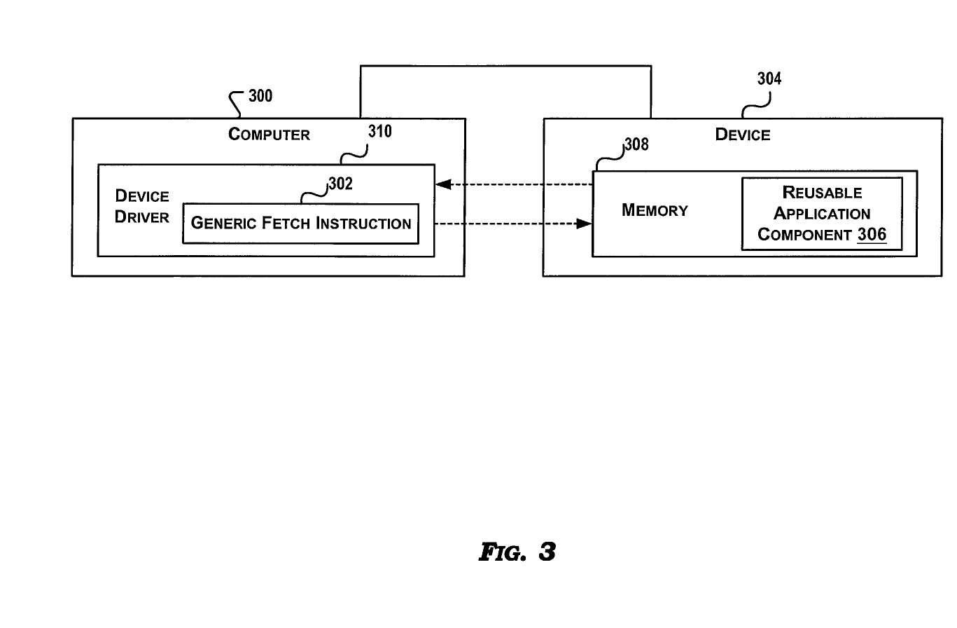

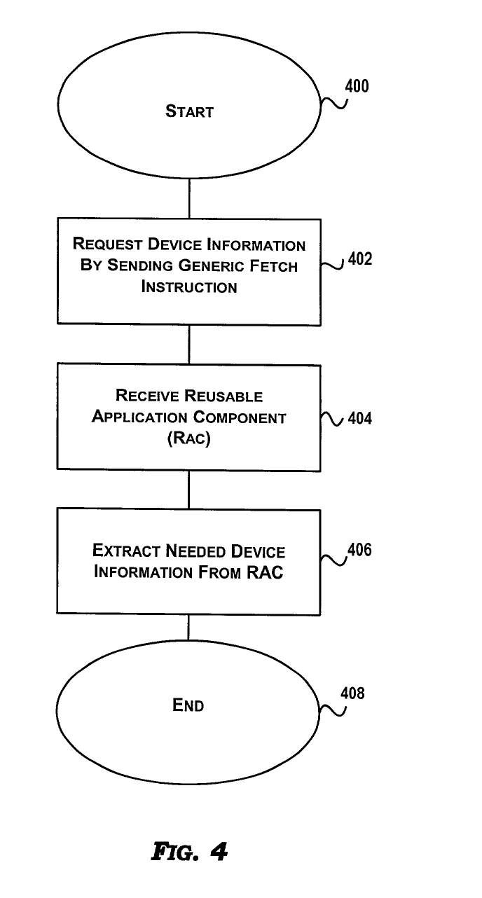

As illustrated in FIG. 3, a device driver 310 on a computer 300 comprises a generic fetch instruction 302 for requesting device information, and a device 304 comprises a reusable application component 306 in which device information can be encoded within a device memory 308. As illustrated in the flowchart of FIG. 4 which starts at block 400, when a computer 300 requests device information from a device 304 having a reusable application component 306, a device driver 310 on the computer 300 sends a generic fetch instruction 302 to the device 304 at block 402, and the device 304 sends back the reusable application component 306. The reusable application component 306 is received at block 404, and needed device information is extracted at block 406. The method ends at block 408.

### Devices

As used herein, a device refers to any system having a state. Thus, a device may include a peripheral (i.e. hard drive, printer) having a state that includes variables such as toner level, temperature, job status, serial number, size, and/or configuration. A device may also include a car having a state that includes variables such as fuel level, oil level, and maximum speed.

It is sometimes necessary for another system to query the status of a device. For example, when a computer sends a print request to a printer, it may need to know what the toner level of the printer is so that it can make certain decisions, such as whether to cancel the job after a predetermined amount of time, or whether to relay the information to the requesting user, for example. Due to one or more changing variables, the state of a device may change. As a result, device information must be updated so that any system that queries the device for device information has the correct and current state of the device. In previous systems, a complicated device driver on a computer would send a fetch instruction that was specific and sometimes even proprietary to the device being queried. For instance, to obtain the temperature of a device, the specific fetch instruction may need to specify a designated location in memory, or it may need to call a function specific to the device in order to obtain the information.

A dynamic and extractable device information object, however, allows a generic fetch instruction to be used, regardless of the device being queried. A dynamic and extractable device information object enables a less complicated device driver on a computer to be used—the device driver sends a generic fetch instruction to the device being queried. A generic fetch instruction is one that need not be proprietary to the device being queried, which is need not be specific to any given device, and which can be used to query information from any device that complies with a given reusable application component implementation. Thus, a given design can specify that all devices comprising a reusable application component for storing device information may be queried using the command get_Bean, for example.

A dynamic and extractable device information object comprises methods and member variables which are available to external systems. Thus, when a system requests device information from a device and receives a reusable application component, the system can use the methods of the reusable application component to extract device information. For instance, a reusable application component may comprise the method get_temperature. When a system receives a reusable application component, it may request the device's temperature by using the method get_temperature. This is in contrast to existing systems, in which only the device would be able to obtain the temperature, and send the temperature to the requesting system.

In a dynamic and extractable device information object, device information may be saved in a programmable memory so that device information can be updated. In the described embodiments of the invention, an EEPROM (Electrically Erasable Programmable Read Only Memory) is used. An EEPROM is a special type of memory that retains its contents until it is erased with an electrical signal. It is also contemplated by embodiments of the invention that other programmable memories, such as an EPROM (Erasable Programmable Read Only memory), a static RAM with a backup battery (such as those used in alarm clocks, for instance), or even a hard disk drive (such as when the device is a hard disk drive) may be used. However, it should be understood that the invention is not intended to be limited to the types of memories discussed herein, and may embody other types of memories.

### Reusable Application Components

A reusable application component is stored in a memory on a device, such as an EEPROM, where device information can be added and updated to the reusable application component. A reusable application component makes its functionality available to various requesting entities, can be connected with other components to create different applications, hides the implementation details, conforms to interfaces, and encapsulates data. As a result, all device information may be encapsulated in a single object such that when the object is requested (using a generic fetch instruction), all information about the device is readily available. This is in contrast to existing systems, where a single fetch instruction would only make the requested device information available to the requesting system.

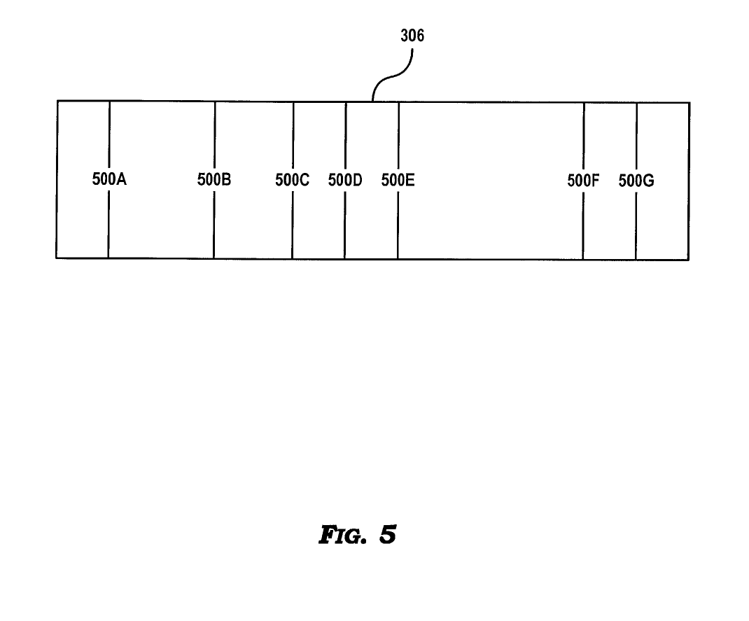

In a preferred embodiment, a reusable application component comprises a pre-built and pre-designed JavaBean® that is built into a device, and then dynamically updated. When a JavaBean® is created, a number of variables are created and may be initialized with device information. As illustrated in FIG. 5, a reusable application component, such as a JavaBean®, may comprise a stream of bytes, where a designated sequence of bytes corresponds to one device variable, and an offset 500A, 500B, 500C, 500D, 500E, 500F, 500G in the stream of bytes differentiates one variable in the JavaBean® from another variable in the JavaBean®. The offsets are identified at the time the JavaBean® is built, so that the variable offsets, (the offsets identifying the locations of the variables in the JavaBean®) can be saved into a table of data offsets in a device memory, or some other medium that can be passed onto a using device. When device information needs to be initialized, or changes during the lifetime of the device, an appropriate variable can be accessed by its variable offset, and the variable can be initialized or updated.

A device comprising a JavaBean® is then ready to be queried by another system, or the JavaBean® and accompanying instructions for programming into a memory are ready for use within a device.

### Querying for Device Information

In an exemplary embodiment of the invention, a computer sends a fetch instruction (written in the C programming language, for example) to a device (such as a hard drive) having a JavaBean®. An application on the computer may query the device for information by using the computer's device driver to send a generic fetch instruction to fetch the JavaBean® that is located on the device being queried for information. When the device receives the command from the computer, the device serializes the JavaBean® (i.e., it transmits the JavaBean® bit by bit) to the computer. The device driver on the computer then deserializes the JavaBean®, and passes it onto the requesting application that extracts the device information that it needs by issuing a method call on the reusable application component. An application may be a user level application, such as an application running on a desktop, or a background health check application, for example.

### Updating Device Information

When the status of a device changes, one or more variables in a reusable application component corresponding to the status changes. In response to modified device information that a device itself may change, or in response to modified device information received from another system, the device accesses a memory in which variable offsets are programmed to determine the location of the variables corresponding to the modified device information in the reusable application component. The appropriate variable(s) can then be accessed, and modified to reflect the correct and current value.

Thus, a method to query device information from a device using a generic fetch instruction to request a reusable application component has been described, resulting in, for example: enabling devices that do not have to support specific operating systems, and that do not have to support virtual machines requiring interpreters and/or chips (i.e., Java Virtual Machine); components that that are reusable and that can be called by other computers and devices; as well as components that are dynamically available and updated. In this manner, generic fetch instructions may be used to query a variety of different devices regarding their capabilities, configuration, and/or state. Additionally, since the devices need not include a virtual machine or related circuitry, cost efficiencies may be achieved.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For example, while embodiments of the invention have been described using a JavaBean® as reusable application component, it should be understood by one of ordinary skill in the art that a reusable application component is not so limited. This invention contemplates the use of any type of reusable application component in combination with systems and devices appropriate and compatible with the reusable application component. For instance, Microsoft's ActiveX technology may be used.

Furthermore, devices embody a wide variety of systems having a state, and so may comprise printers, hard drives, automobiles, and telephones, for instance, but again, are not limited thereto. Other examples which are not intended to be limited include fetch instructions, which may be written in any language appropriate to a given implementation, and programmable memories, such as EEPROMs and EPROMs.

What is claimed is:

1. A method to query device information from a device, comprising:
issuing a generic fetch instruction to a device to request a reusable application component from the device, the reusable application component comprising one or more variables each corresponding to device information; and
extracting one or more of the variables from the reusable application component.

2. The method of claim 1, wherein the reusable application component comprises a JavaBean®.

3. The method of claim 2, wherein the device does not include a Java Virtual Machine environment.

4. The method of claim 1, wherein a first variable is differentiated from a second variable by a variable offset.

5. The method of claim 1, wherein extracting a given one of the variables from the reusable application component comprises issuing a method call on the reusable application component.

6. A method to make device information available, comprising:
maintaining a reusable application component having a number of variables differentiated from one another by variable offsets, each variable corresponding to information about a device;
updating the reusable application component when device information changes;
sending the reusable application component when a request is made for device information.

7. The method of claim 6, wherein updating the reusable application component comprises:
accessing a memory in which the variable offsets are stored to determine one or more locations in the reusable application component associated with changed device information; and
updating one or more variables corresponding to the changed device information at the one or more locations in memory specified by the variable offsets.

8. The method of claim 6, additionally comprising initializing the reusable application component.

9. The method of claim 8, wherein said initializing the reusable application component comprises:
accessing a memory in which the variable offsets are stored to determine one or more locations in the reusable application component associated with device information to be initialized; and
updating one or more variables corresponding to the device information to be initialized at the one or more locations in memory specified by the variable offsets.

10. The method of claim 6, wherein the reusable application component comprises a JavaBean®.

11. The method of claim 10, wherein the device does not include a Java Virtual Machine environment.

12. A method to request device information from a device, comprising:
receiving a request from an application for device information;
sending a fetch instruction to the device;
receiving a reusable application component having one or more variables differentiated from one another by variable offsets, and each corresponding to device information; and
passing the reusable application component to the requesting application which extracts device information from the reusable application component.

13. The method of claim 12, wherein the reusable application component comprises a JavaBean®.

14. The method of claim 13, wherein the device does not include a Java Virtual Machine environment.

15. The method of claim 12, wherein the fetch instruction is an instruction that is generic to the device.

16. The method of claim 12, wherein the requesting application extracts device information from the reusable application by issuing a method call on the reusable application component.

17. A device comprising:
a programmable memory to store a reusable application component, the reusable application component having one or more variables differentiated from one another by variable offsets, each corresponding to device information;
a first port on which to receive a request for device information;
a second port on which to send the reusable application component.

18. The device of claim 17, wherein the first port and the second port comprise the same port.

19. The device of claim 17, wherein said programmable memory comprises an EEPROM (Electrically Erasable Programmable Read Only Memory).

20. A system, comprising:
a device having a memory on which a reusable application component for maintaining information about the device is stored, the reusable application component comprising one or more variables differentiated from one another by variable offsets, and each corresponding to device information; and
a computer system having a device driver corresponding to the device, the device driver to request device information by:
sending a generic fetch instruction to the device;
receiving a reusable application component from the device; and
passing the reusable application component to an application which extracts one or more variables from the reusable application component.

21. The system of claim 20, wherein said device memory comprises an EEPROM (Electrically Erasable Programmable Read Only Memory).

22. The system of claim 20, wherein the application extracts a given one of the variables from the reusable application component by issuing a method call on the reusable application component.

23. A machine-readable medium having stored thereon data representing sequences of instructions, the sequences of instructions which, when executed by a processor, cause the processor to:
use a generic fetch instruction to request a reusable application component from the device, the reusable application component comprising one or more variables each corresponding to device information; and
extract one or more of the variables from the reusable application component.

24. The machine-readable medium of claim 23, wherein the reusable application component comprises a JavaBean®.

25. The machine-readable medium of claim 24, wherein the device does not include a Java Virtual Machine environment.

26. The machine-readable medium of claim 23, wherein a first variable is differentiated from a second variable by a variable offset.

27. The machine-readable medium of claim 23, wherein the processor extracts a given one of the variables from the reusable application component by issuing a method call on the reusable application component.

28. A machine-readable medium having stored thereon data representing sequences of instructions, the sequences of instructions which, when executed by a processor, cause the processor to perform the following:
receive a request from an application for device information;
send a fetch instruction to the device;
receive a reusable application component having one or more variables differentiated from one another by variable offsets, and each variable corresponding to device information; and
pass the reusable application component to the requesting application to extract device information from the reusable application component.

29. The machine-readable medium of claim 28, wherein the reusable application component comprises a JavaBean®.

30. The machine-readable medium of claim 29, wherein the device does not include a Java Virtual Machine environment.

31. The machine-readable medium of claim 28, wherein the fetch instruction is an instruction that is generic to the device.

32. The machine-readable medium of claim 28, wherein the processor extracts device information from the reusable application by issuing a method call on the reusable application component.

33. An apparatus for querying device information from a device, comprising:
means for sending a generic instruction to a device to request a reusable application component from the device, the reusable application component comprising one or more variables each corresponding to device information; and
means for extracting one or more of the variables from the reusable application component.

34. An apparatus for querying device information from a device, comprising:
means for receiving a request from an application for device information;
means for sending a fetch instruction to the device;
means for receiving a reusable application component having one or more variables differentiated from one another by variable offsets, and each variable corresponding to device information; and
means for passing the reusable application component to the requesting application to extract device information from the reusable application component.
